(19) United States
(12) Patent Application Publication
(10) Pub. No.: US 2008/0031259 A1
(43) Pub. Date: Feb. 7, 2008

(54) Method and system for replicating traffic at a data link layer of a router

(75) Inventor: Geoffrey R. Zampiello, Norwalk, CT (US)

Correspondence Address: TOLER LAW GROUP, 8500 BLUFFSTONE COVE, SUITE A201, AUSTIN, TX, 78759, US

(73) Assignee: SBC Knowledge Ventures, LP, Reno, NV (US)

(21) Appl. No.: 11/497,507

(22) Filed: Aug. 1, 2006

(51) Int. Cl. H04L 12/56

(52) U.S. Cl. 370/395.52

(57) ABSTRACT

A router provides a respective primary IP termination point for each of a plurality of users including a first user and a second user. The router comprises a data-link-layer component to replicate IP traffic between the first user and the second user.

### FIELD OF THE DISCLOSURE

The present disclosure is generally related to methods and systems for replicating Internet Protocol (IP) traffic.

### BACKGROUND

In applications such as Lawfully Authorized Electronic Surveillance (LAES), IP traffic associated with a particular user of an IP data network is to be captured and replicated. The IP data network may comprise one or more routers used to aggregate multiple users and IP addresses. The IP traffic associated with the particular user is captured at a point within the IP data network above a default router of a routing device.

### BRIEF DESCRIPTION OF THE DRAWINGS

FIG. 1 is a block diagram of an embodiment of a system for capturing IP traffic including intra-router, peer-to-peer traffic;

FIGS. 2 and 3 are a flow chart of an embodiment of a method of capturing IP traffic including intra-router, peer-to-peer traffic using the system of FIG. 1; and

FIG. 4 is a block diagram of an illustrative embodiment of a general computer system.

### DETAILED DESCRIPTION OF THE DRAWINGS

Existing methods for capturing and replicating IP traffic on an IP router do not address capturing peer-to-peer traffic between two users that both terminate on the IP router, or between two users from the same point of presence. Disclosed herein are embodiments of methods and systems for capturing and replicating IP traffic between two users that both terminate on the same IP router, or between two users from the same point of presence. In an embodiment, the IP traffic is captured and replicated on a per-user basis, below a layer of a default router, and at a primary IP termination point of the user.

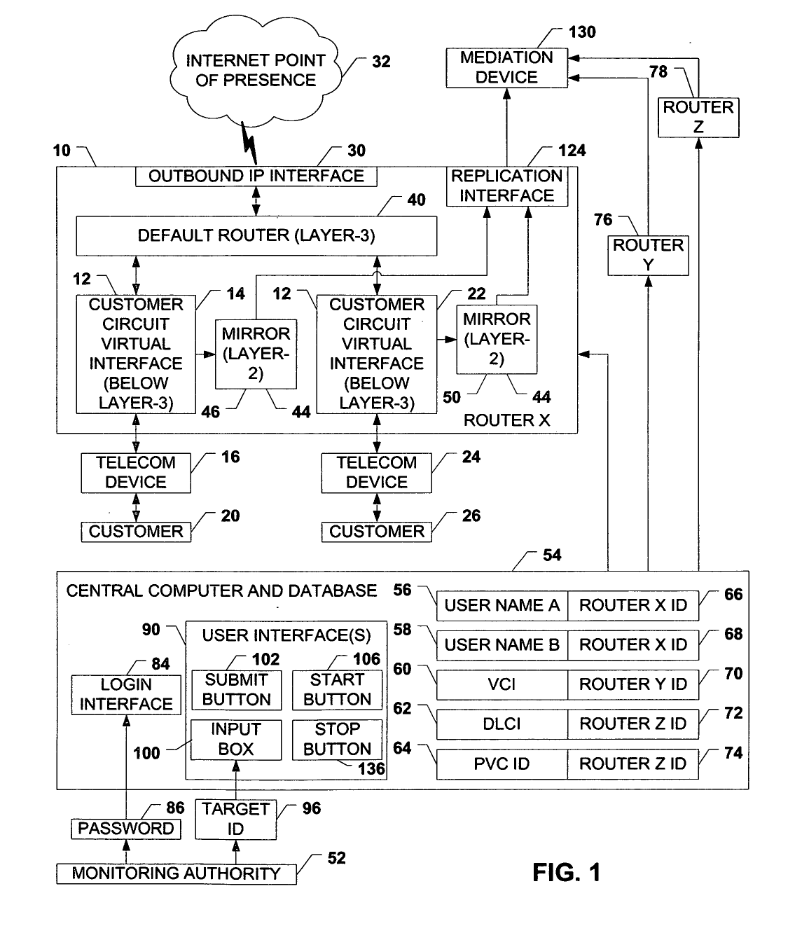

FIG. 1 is a block diagram of an embodiment of a system for capturing IP traffic including intra-router, peer-to-peer traffic. A router 10, which may comprise a consumer IP router, a commercial IP router or another IP aggregation device, provides a first-hop router for a group of users or customers. The router 10 comprises a plurality of customer circuit virtual interfaces 12. The customer circuit virtual interfaces 12 operate below Layer-3, or below a network layer, of an Open Systems Interconnection (OSI) model.

Each of the customer circuit virtual interfaces 12 provides a primary point of termination of a corresponding user or customer. For example, the router 10 may comprise a first customer circuit virtual interface 14 that provides a primary point of termination for a first telecommunication device 16 of a first customer 20, and a second customer circuit virtual interface 22 that provides a primary point of termination for a second telecommunication device 24 of a second customer 26. Those having ordinary skill will recognize that the router 10 may comprise any number of customer circuit virtual interfaces 12 to provide primary points of termination for any number of customers. Examples of the telecommunication devices include, but are not limited to, computers, IP telephones, IP television receivers, other television set-top boxes, game players and other customer premises equipment.

The router 10 aggregates traffic that is received from the customer circuit virtual interfaces 12 and is to be communicated deeper into an IP network. The aggregated traffic is outputted via an IP interface 30 to an Internet point of presence 32. The Internet point of presence 32 may provide access to the Internet, the World Wide Web (WWW), and video servers, for example. The router 10 further serves to receive incoming traffic from the Internet point of presence 32 and route the incoming traffic to its intended destination (e.g. route each incoming packet to its intended customer circuit virtual interface). The router 10 still further serves to route traffic between pairs of the customer circuit virtual interfaces 12 (e.g. route traffic between the first customer 20 and the second customer 26).

IP address space is assigned to the various users of the router 10 to facilitate the routing of traffic between the users and the IP interface 30 (e.g. to the Internet, WWW or video servers), and traffic between pairs of users of the router 10. The users may comprise broadband users whose IP addresses are assigned either dynamically or statically. Alternatively, the users may comprise dial-up users whose IP addresses are assigned either dynamically or statically. As another alternative, the users may comprise dedicated customers who are assigned a pool of dynamically or statically assigned IP addresses.

Each of the customer circuit virtual interfaces 12 is assigned to a corresponding IP address. For example, the first customer circuit virtual interface 14 may be assigned to a first IP address, and the second customer circuit virtual interface 22 may be assigned to a second IP address that differs from the first IP address.

The router 10 comprises a default router 40 having its own IP address that differs from the first IP address and the second IP address. The default router 40 serves to move traffic from one interface to another interface. The default router 40 may be implemented using software within the router 10. The default router 40 operates at Layer-3, or the network layer, of the OSI model.

To determine how to move the traffic, the default router 40 serves to determine a next hop for each IP packet that it receives. Consider an IP packet that is generated by one of the customers and is received from one of the customer circuit virtual interfaces 12. Consider the default router 40 determining that a next hop destination for the IP packet is located on the same router 10. In the above-described scenario, the IP packet will not leave an IP egress side of the router 10 (i.e. will not be outputted via the IP interface 30), but rather will be routed to and outputted by another one of the customer circuit virtual interfaces 12. The above-described scenario occurs for intra-router, peer-to-peer communications, wherein the aforementioned IP packet may be described as being “hair-pinned” within the software and hardware of the router 10. Thus, IP traffic associated with intra-router, peer-to-peer communication between the first customer 20 and the second customer 26 does not go past the default router 40.

The router 10 comprises a plurality of mirror components 44 which selectively perform a mirror function at any of the customer circuit virtual interfaces 12. For example, a first mirror component 46 can perform a mirror function at the first customer circuit virtual interface 14 to intercept communications to and/or from the first customer 20, and a second mirror component 50 can perform a mirror function at the second customer circuit virtual interface 22 to intercept communications to and/or from the second customer 26.

Each of the mirror components 44 is selectively activated or deactivated as requested by a monitoring authority 52. The monitoring authority 52 may cause a request to intercept communications for a particular target to be sent to the router 10. The particular target may comprise one or more particular customers, interfaces, or other identifiable entities. Based on the request, the router 10 activates those one or more mirror components at the point-of-entry interfaces associated with the particular target (e.g. the point-of-entry interfaces at which the one or more particular customers are terminated). Mirror components for non-targeted customers are not activated. This selective activation enables IP traffic to be captured on a per-user basis. Similarly, the monitoring authority 52 may cause a subsequent request to stop intercepting communications for a particular target or for one or more particular customers to be sent to the router 10. Based on the subsequent request, the router 10 deactivates those one or more mirror components at the point-of-entry interfaces associated with the particular target (e.g. the point-of-entry interfaces at which the one or more particular customers are terminated). The requests can be made to the router 10 using commands and/or messages directly from the monitoring authority 52 or indirectly from the monitoring authority 52 via a central computer/database 54.

The monitoring authority 52 can identify the particular target in various ways. The particular target can be identified by a target's user name (e.g. for point-to-point access), by a virtual circuit identifier (VCI) (e.g. for a dynamic or bridged access), or by a data link connection identifier (DLCI) or a permanent virtual circuit (PVC) identifier (e.g. if a target user has dedicated Internet access). The router 10 receives the identifying information for the target, and determines which one or more of the mirror components 44 to activate or deactivate based on the identifying information.

The identifying information for a plurality of different users of a network of a plurality of routers (including the router 10) may be stored in a central computer/database 54. The central computer/database 54 may store a key identifier for each user on the network. To illustrate examples of the key identifiers, the central computer/database 54 may identify a first user by a first user name 56, a second user by a second user name 58, a third user by a VCI 60, a fourth user by a DLCI 62, and a fifth user by a PVC identifier 64. An IP address of a user may also be used as a key identifier for the user. The central computer/database 54 also indicates, for each user, which router is assigned to the user. For example, the central computer/database 54 may include data 66 and 68 to indicate that the router 10 is assigned to first user and the second user, data 70 to indicate that a second router 76 is assigned to the third user, and data 72 and 74 to indicate that a third router 78 is assigned to the fourth user and the fifth user. The central computer/database 54 may use a lightweight directory access protocol (LDAP), for example.

The central computer/database 54 can automatically update any information associated with a user in response to a change in the information. For example, if a user's IP address changes to a new IP address (e.g. if the user's IP address is dynamically assigned), the central computer/database 54 may store the new IP address for the user.

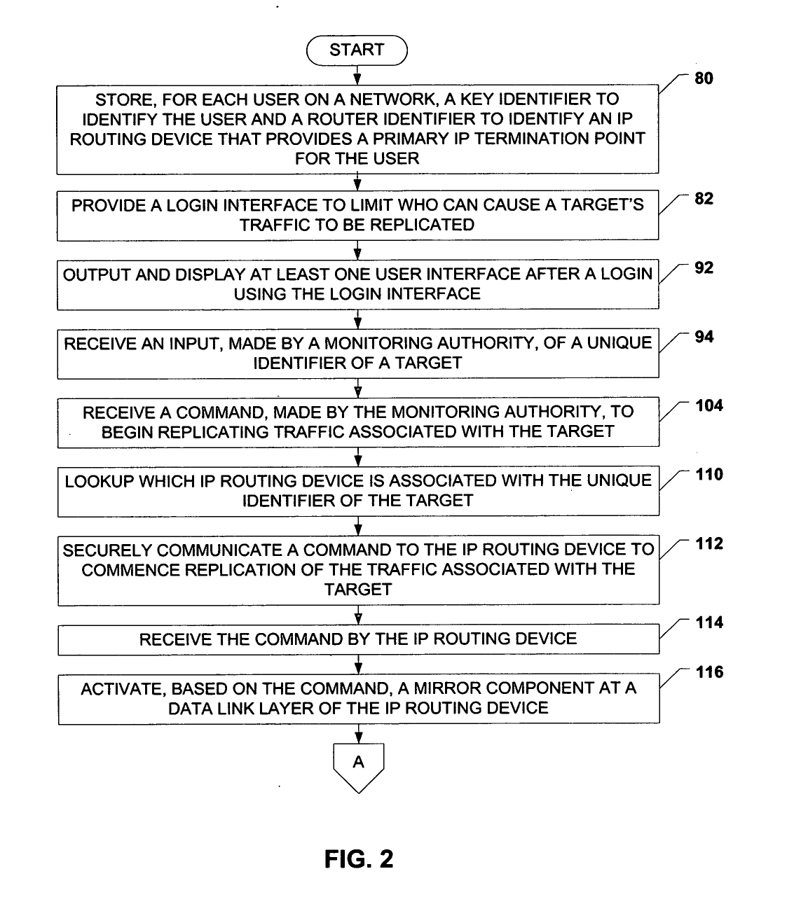

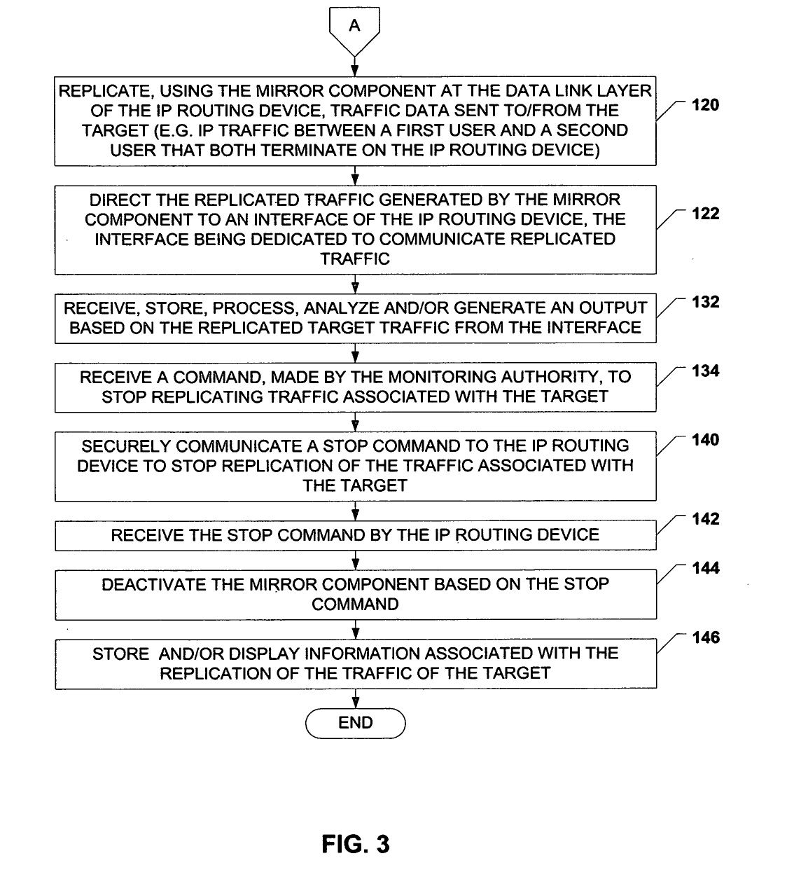

FIGS. 2 and 3 are a flow chart of an embodiment of a method of capturing IP traffic including intra-router, peer-to-peer traffic using the system of FIG. 1. As indicated by block 80, the method comprises storing, for each user on the network, a key identifier to identify the user and a router identifier to identify an IP routing device that is used by the user. The association between the key identifier and the router identifier may be stored in the central computer/database 54.

As indicated by block 82, the method comprises providing a login interface 84 to limit who can cause a target's traffic to be replicated. The login interface 84 may be provided by the central computer/database 54. The login interface 84 may require the monitoring authority 52 to enter a password 86 before enabling a target's traffic to be replicated. The password 86 may comprise a secure, one-time password.

After the monitoring authority 52 is successfully logged in via the login interface 84, the method comprises outputting and displaying at least one user interface 90, as indicated by block 92. The at least one user interface 90 may be outputted by the central computer/database 54 for display to the monitoring authority 52. The at least one user interface 90 may comprise one or more graphical user interfaces.

As indicated by block 94, the method comprises receiving an input, made by the monitoring authority 52, of a unique identifier 96 of a target. The at least one user interface 90 may comprise a screen having an input box 100, such as a text box, to receive the input of the unique identifier 96 of the target. The at least one user interface 90 may comprise a submit button 102 or alternative control that, when clicked or otherwise selected by the monitoring authority 52, submits the unique identifier 96 of the target to the central computer/database 54.

As indicated by block 104, the method comprises receiving a command, made by the monitoring authority 52, to being replicating traffic associated with the target identified by the unique identifier 96. The at least one user interface 90 may comprise a start button 106 or alternative control that is clickable or otherwise selectable by the monitoring authority 52 to issue the command to begin.

As indicated by block 110, the method comprises looking up which IP routing device is associated with the unique identifier 96 of the target. The lookup operation is performed by the central computer/database 54. The lookup can be performed based on a user name, an IP address, a VCI, a DLCI, or a PVC identifier of the target. For purposes of illustration and example, consider the unique identifier 96 comprising the first user name 56, where the first user name 56 identifies the first customer 20. Because the first user name 56 is associated with the data 66 indicating the router 10, the lookup operation in this example determines that the router 10 is the IP routing device that provides the primary IP termination point for the target.

As indicated by block 112, the method comprises the central computer/database 54 securely communicating a command to the IP routing device (e.g. the router 10) associated with the unique identifier 96 of the target. The command is for the IP routing device to commence replication of traffic associated with the unique identifier 96 of the target.

As indicated by blocks 114 and 116, the IP routing device receives the command and activates a mirror component (e.g. the mirror component 46) based on the command. The mirror component is to perform a mirror function for a customer circuit virtual interface associated with the target. When activated, the mirror component replicates the IP packets of a target's traffic on a 1:1 ratio without modifying a packet's destination address.

As indicated by block 120, traffic data sent to the target and traffic data sent from the target are replicated by the mirror component. The mirror component performs data replication at a data link layer (Layer-2) of an OSI model before a first-hop Layer-3 route is applied. Replicating the data at a data link layer, instead of a network layer, mitigates the potential for missing replication of some of the target's traffic. For example, the mirror component 46 can replicate traffic between the first customer 20 and the second customer 26 that both terminate on the router 10. Further, authenticity of the replicated traffic is promoted by replicating the data before Layer-3 processing. Still further, replicating the data at Layer-2 instead of Layer-1 (an example of Layer-1 replication being with inline taps in front of the router 10) facilitates replicating and storing traffic only for particular targets, and not for other non-targeted users.

As indicated by block 122, the replicated traffic generated by the mirror component is directed to a replication interface 124 that is dedicated to communicate replication traffic. The replication interface 124 is separate from the IP interface 30. The replication interface 124 may comprise a secure tunnel or a secure interface. A termination point of the replication interface 124 is configured to catch all destination IP addresses. Via the replication interface 124, the replication traffic is ultimately. communicated to a mediation device 130. The mediation device 130 may comprise a secure server or another computer.

As indicated by block 132, the mediation device 130 performs any one or more of receiving, storing, processing, analyzing and generating an output based on the target's traffic. The output may comprise a displayed output generated by a display device, or a hard copy output generated by a hard copy device such as a printer.

As indicated by block 134, the method comprises receiving a command, made by the monitoring authority 52, to stop replicating traffic associated with the target identified by the unique identifier 96. The at least one user interface 90 may comprise a stop button 136 or alternative control that is clickable or otherwise selectable by the monitoring authority 52 to issue the command to stop. The stop button 136 may be provided to the monitoring authority 52 in response to the monitoring authority 52 inputting the unique identifier 96 of the target and clicking or otherwise selecting a submit button. In this way, the replication process is continued until commanded to stop by the monitoring authority 52.

As indicated by block 140, the method comprises the central computer/database 54 securely communicating a stop command to the IP routing device (e.g. the router 10) associated with the unique identifier 96 of the target. The stop command is for the IP routing device to stop replication of traffic associated with the unique identifier 96 of the target.

As indicated by blocks 142 and 144, the IP routing device receives the stop command and deactivates the mirror component (e.g. the mirror component 46) based on the stop command.

As indicated by block 146, the method comprises storing and/or displaying information associated with the replication of traffic of the target. The information may be stored by the central computer/database 54, and outputted for display to the monitoring authority 52. The information may comprise any combination of a start time indicating an actual time at which the replication of the target's traffic was commenced, a stop time indicating an actual time at which the replication of the target's traffic was stopped, a replication duration indicating how much time the target's traffic was replicated, one or more credentials of a person who initiated the replication in the monitoring authority 52, and information (e.g. an impetus identifier) indicating an impetus for the replication.

Thus, the mirror components 44 perform the mirror functions at an edge of the network, below the default router plane of the router 10, to ensure that intra-router, peer-to-peer communications can be selectively intercepted and sent to the mediation device 130. The mirror components 44 also enable external communications between the customer circuit virtual interfaces 12 and the Internet point of presence 32 to be selectively intercepted and sent to the mediation device 130. The mirror components 44 can be implemented in software and/or hardware of the router 10.

Preferably, the replication performed by the mirror components 44 is either substantially or completely undetectable by the target, e.g. the IP routing does not appear to differ from a normal IP routing experience for the target. This is in contrast to alternatives where a target may be alerted to being monitored. One alternative is to direct the target from its normal default router to an alternative default router that cooperates to replicate the target's traffic. A large pool of users of a consumer broadband service, including the target, may share the normal default router. To terminate the target on a replication device using a Layer-2 Tunneling Protocol (L2TP) tunnel, for example, the target is assigned an IP address from a non-contiguous pool in relation to the target's normal pool. Consequently, a targeted user may be alerted to being monitored by noticing that he/she is assigned an atypical IP address (e.g. from the non-contiguous pool) and/or that a foreign route at an L2TP Network Server (LNS) appears in response to performing a trace route. In contrast, replicating the traffic at a data link layer, as disclosed herein, is less likely to be discovered by the target because the target's normal route has not changed.

Similar to the router 10, the routers 76 and 78 may enable traffic replication at a data link layer below a default router, and on a per-customer basis at a customer's primary IP termination. The monitoring authority 52 can use the central computer/database 54 to select a particular user of the router 76 or the router 78. The central computer/database 54, in turn, commands either the router 76 or the router 78 to start and stop a replication process for the particular user. Replicated traffic may be outputted by replication interfaces of the routers 76 and 78 for secure communication to the mediation device 130. The mediation device 130 may receive, store, process, analyze and/or generate an output based on the replicated traffic.

The herein-disclosed embodiments may be used in various applications and/or by various network service providers. For example, a broadband Internet service provider can use the teachings herein to capture IP traffic on a router, including intra-router peer-to-peer traffic, for use in a Communications Assistance for Law Enforcement Act (CALEA) application. The broadband Internet service provider can discreetly provide a record of LP traffic to and from a particular host or group of hosts.

It is noted that the central computer/database 54 can be used by more than one person having authority to cause traffic to be replicated. It is also noted that the central computer/database 54 may have components that are either at the same location or at different locations. For example, the central computer/database 54 may comprise a computer (e.g. that provides the user interfaces 84 and 90) and a database (e.g. that stores and associates the key identifiers with the router identifiers) that are either at the same location or at different locations.

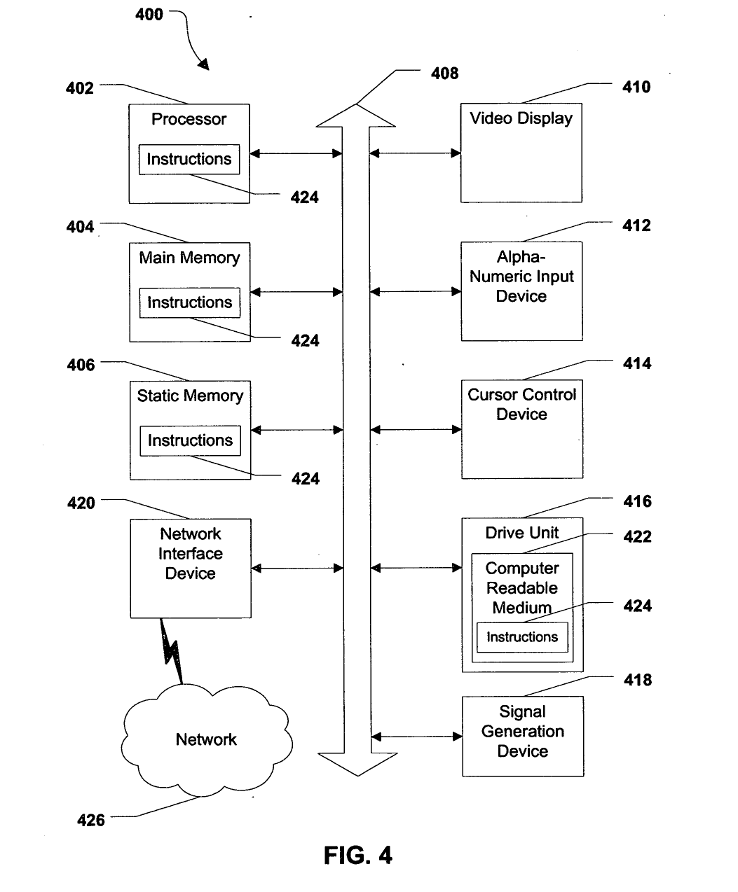

Referring to FIG. 4, an illustrative embodiment of a general computer system is shown and is designated 400. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. Moreover, the computer system 400 can include a main memory 404 and a static memory 406, that can communicate with each other via a bus 408. As shown, the computer system 400 may further include a video display unit 410, such as a liquid crystal display (LCD), an organic light emitting diode (OLED), a flat panel display, a solid state display, or a cathode ray tube (CRT). Additionally, the computer system 400 may include an input device 412, such as a keyboard, and a cursor control device 414, such as a mouse. The computer system 400 can also include a disk drive unit 416, a signal generation device 418, such as a speaker or remote control, and a network interface device 420.

In a particular embodiment, as depicted in FIG. 4, the disk drive unit 416 may include a computer-readable medium 422 in which one or more sets of instructions 424, e.g. software, can be embedded. Further, the instructions 424 may embody one or more of the methods or logic as described herein. In a particular embodiment, the instructions 424 may reside completely, or at least partially, within the main memory 404, the static memory 406, and/or within the processor 402 during execution by the computer system 400. The main memory 404 and the processor 402 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 424 or receives and executes instructions 424 responsive to a propagated signal, so that a device connected to a network 426 can communicate voice, video or data over the network 426. Further, the instructions 424 may be transmitted or received over the network 426 via the network interface device 420.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. A method comprising:
replicating, at a data link layer of an Internet Protocol (IP) router, IP traffic between a first user and a second user that both terminate on the IP router.

2. The method of claim 1 further comprising:
receiving, by the IP router, a first command to activate an IP mirror component associated with an interface of the first user;
wherein said replicating at the data link layer of the IP router is performed by the IP mirror component.

3. The method of claim 2 further comprising:
receiving, by the IP router, a second command to deactivate the IP mirror component associated with the interface of the first user; and
stopping said replicating at the data link layer of the IP router based on the second command.

4. The method of claim 2 further comprising:
storing, in a database, data indicating which of a plurality of IP routing devices in a network provides a respective primary IP termination point for each of a plurality of users of the network;
receiving a command to replicate the IP traffic associated with the first user;
performing a lookup of the database to determine that the IP router provides the primary IP termination point for the first user; and
based on the lookup, communicating the first command to the IP router.

5. The method of claim 4 wherein the lookup is performed based on a user name identifier of the first user.

6. The method of claim 4 wherein the lookup is performed based on a virtual circuit identifier of the first user.

7. The method of claim 4 wherein the lookup is performed based on a data link connection identifier (DLCI) of the first user.

8. The method of claim 4 wherein the lookup is performed based on a permanent virtual circuit (PVC) identifier of the first user.

9. The method of claim 4 wherein the lookup is performed based on an IP address of the first user.

10. The method of claim 1 further comprising:
outputting replicated IP traffic between the first user and the second user by an interface of the IP router, the interface being separate from an IP interface of the IP router, the IP interface to receive aggregated traffic to be routed to the first user and the second user.

11. A router to provide a respective primary Internet Protocol (IP) termination point for each of a plurality of users including a first user and a second user, the router comprising:
a data-link-layer component to replicate IP traffic between the first user and the second user.

12. The router of claim 11 further comprising:
a first interface to provide a first primary IP termination point for the first user;
wherein the data-link-layer component comprises a first IP mirror component associated with the first interface.

13. The router of claim 12 wherein the first IP mirror component is to replicate, at a data link layer, the IP traffic at the first interface in response to a first command to activate the first IP mirror component.

14. The router of claim 13 wherein the first IP mirror component is to stop replicating the IP traffic at the first interface in response to a second command to deactivate the first IP mirror component.

15. The router of claim 12 further comprising:
a second interface to provide a second primary IP termination point for the second user; and
a second IP mirror component associated with the second interface.

16. The router of claim 15 wherein the second IP mirror component is inactive to replicate the IP traffic while the first IP mirror component is active to replicate the IP traffic.

17. The router of claim 11 further comprising:
an IP interface to receive aggregated traffic to be routed to the first user and the second user; and
an interface separate from the IP interface, the interface to output replicated IP traffic between the first user and the second user from the data-link-layer component.

18. An apparatus comprising:
a database which stores data indicating which of a plurality of Internet Protocol (IP) routing devices in a network provides a respective primary IP termination point for each of a plurality of users of the network, the database indicating that a first IP router provides a first primary IP termination point for a first user and a second primary IP termination point for a second user, the database indicating that a second IP router provides a third primary IP termination point for a third user; and
a computer to receive a command to replicate the IP traffic associated with the first user, the computer to perform a lookup of the database to determine that the first router provides the first primary IP termination point for the first user, and based on the lookup, to communicate a command to the first router to begin replicating IP traffic associated with the first user at a data link layer, the IP traffic including IP traffic between the first user and the second user.

19. The apparatus of claim 18 wherein the lookup is performed based on a user name identifier of the first user.

20. The apparatus of claim 18 wherein the lookup is performed based on a virtual circuit identifier of the first user.

21. The apparatus of claim 18 wherein the lookup is performed based on a data link connection identifier (DLCI) of the first user.

22. The apparatus of claim 18 wherein the lookup is performed based on a permanent virtual circuit (PVC) identifier of the first user.

23. The apparatus of claim 18 wherein the lookup is performed based on an IP address of the first user.
